(19) United States
(12) Patent Application Publication
(10) Pub. No.: US 2008/0022529 A1
(43) Pub. Date: Jan. 31, 2008

(54) Shaving razor with trimming blade

(75) Inventors: Michael J. Gray, Duxbury, MA (US); Craig Provost, Boston, MA (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Gillette Company

(21) Appl. No.: 11/904,443

(22) Filed: Sep. 27, 2007

Related U.S. Application Data
(63) Continuation of application No. 10/798,541, filed on Mar. 11, 2004.

(51) Int. Cl. B26B 19/00

(52) U.S. Cl. 30/34.1

(57) ABSTRACT

A shaving razor including a housing having a primary guard at a front of the housing and a primary cap at an upper surface at a back of the housing, one or more primary shaving blades between the primary guard and said primary cap, and a trimming blade mounted at the back of the housing having a trimming blade cutting edge oriented away from the upper surface. The razor also has an elongated handle having a curve at end secured to the housing, with the curve being concave on the same side as the primary blades. The elongated handle can also have a finger pad at the end of the handle secured to the housing on the same side as the primary blades. The elongated handle can also be bifurcated at the end of the handle secured to the housing into two portions such that there is a region between the two portions.

### CROSS REFERENCE TO RELATED APPLICATION

This application is a continuation of application Ser. No. 10/798,541 filed Mar. 11, 2004.

### BACKGROUND OF THE INVENTION

The invention relates to a shaving razor having a trimming blade.

In recent years shaving razors with various numbers of blades have been proposed in the patent literature and commercialized, as described, e.g., in U.S. Pat. No. 5,787,586, which generally describes a type of design that has been commercialized as the three-bladed Mach III razor by The Gillette Company.

Increasing the number of blades on a shaving razor generally tends to increase the shaving efficiency of the razor and provide better distribution of compressive forces on the skin but it can also tend to increase drag forces, reduce maneuverability, and reduce the ability to trim, e.g., sideburns or near the nose. U.S. Pat. No. 6,276,061, which is hereby incorporated by reference, describes locating an extra blade mounted on an angled blade support at the rear of a three-bladed razor for trimming. The patent does not describe how the blade is secured on the housing, and shows it attached on the type of cartridge and handle design employed in the Mach III razor, as shown in FIG. 14 hereto.

### SUMMARY OF THE INVENTION

In one aspect, the invention features, in general, a shaving razor including a housing having a primary guard at a front of the housing and a primary cap at an upper surface at a back of the housing, one or more primary shaving blades between the primary guard and said primary cap, and a trimming blade mounted at the back of the housing having a trimming blade cutting edge oriented away from the upper surface. The razor also has an elongated handle having a curve at end secured to the housing, with the curve being concave on the same side as the primary blades.

In another aspect, the invention features, in general a shaving razor including a housing having a primary guard, a primary cap, one or more primary shaving blades between the primary guard and the primary cap, a trimming blade at the back of the housing having a cutting edge oriented away from the upper surface, and an elongated handle having a finger pad at the end of the handle secured to the housing on the same side as the primary blades.

In another aspect, the invention features, in general a shaving razor including a housing having a primary guard, a primary cap, one or more primary shaving blades between the primary guard and the primary cap, a trimming blade at the back of the housing having a cutting edge oriented away from the upper surface, and an elongated handle that is bifurcated at the end of the handle secured to the housing into two portions such that there is a region between the two portions.

Particular embodiments of the invention may include one or more of the following features. The finger pad can be made of elastomeric material. The handle can have relieved portions providing access to the finger pad. There can be three or four or five or more primary blades. The housing can be pivotally connected to the handle by a connection that has an at rest stop position to prevent pivoting of said housing when the trimming blade is cutting hair.

Embodiments of the invention may include one or more of the following advantages. The curve in the handle on the same side as the primary blades, the finger pad on the same side, and the access to the finger pad provided by the bifurcated handle permit the user to place a thumb or finger in line with and directly under the trimming blade when trimming sideburns or other whiskers or hairs on user's skin in order to provide greater accuracy and control.

Other advantages and features of the invention will be apparent from the following description of particular embodiments and from the claims.

### BRIEF DESCRIPTION OF DRAWINGS

FIG. 1 is a perspective view of a shaving razor.

FIG. 2 is a perspective view of the FIG. 1 razor showing its replaceable cartridge separated from its handle.

FIG. 3 is perspective view of a blade unit of the FIG. 1 razor with the primary blades removed.

FIG. 4 is a plan view of a trimming assembly of the FIG. 3 blade unit.

FIG. 5 is a rear elevation of the FIG. 4 trimming assembly.

FIG. 6 is a bottom view of the FIG. 4 trimming assembly.

FIG. 7 is a front elevation of the FIG. 4 trimming assembly.

FIG. 8 is a vertical sectional view, taken at 8-8 of FIG. 6, of the housing of the FIG. 3 blade unit.

FIG. 9 is a vertical sectional view, taken at 9-9 of FIG. 6, of a portion of the FIG. 3 blade unit.

FIG. 10 is a vertical sectional view, taken at 9-9 of FIG. 6, of a portion of the FIG. 3 blade unit.

FIG. 11 is a perspective view of the FIG. 3 blade unit with the blades removed.

FIG. 12 is a perspective view of the rear of the housing of the FIG. 3 blade unit.

FIG. 13 is a perspective view of a blade carrier component of an alternative embodiment of a trimming assembly with the trimming blade removed.

FIG. 14 shows a prior art apparatus being applied to the skin for shaving.

FIG. 15 shows the FIG. 1 razor being applied to the skin for shaving.

FIG. 16 shows the FIG. 1 razor rotated 90° from the orientation shown in FIG. 15.

### DETAILED DESCRIPTION OF PARTICULAR EMBODIMENTS

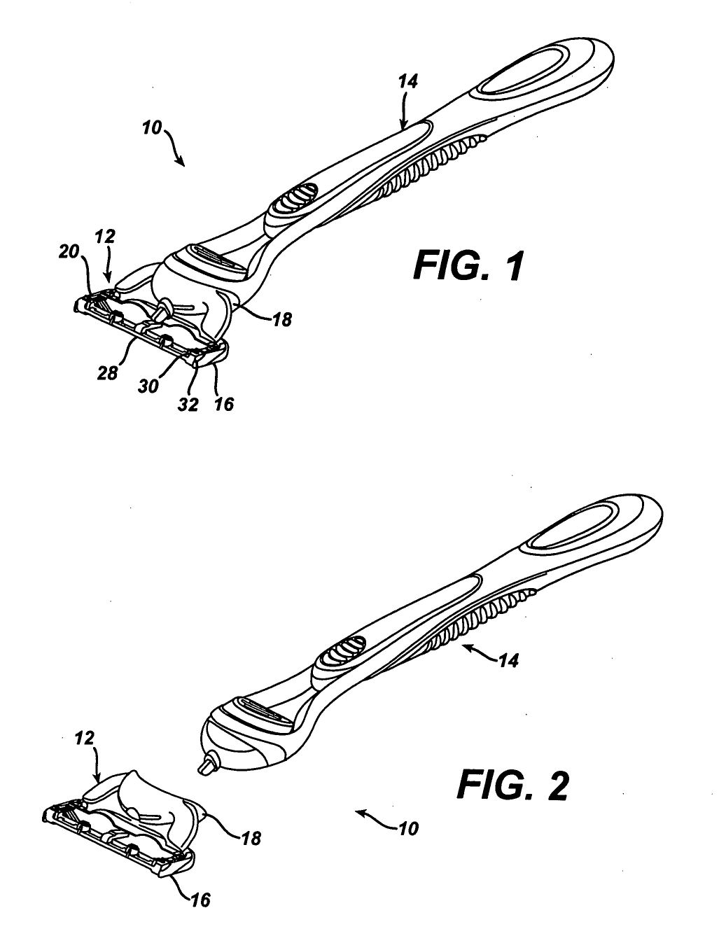

Referring to FIGS. 1 and 2, shaving razor 10 includes disposable cartridge 12 and handle 14. Cartridge 12 includes a connecting member 18, which connects to handle 14, and a blade unit 16, which is pivotally connected to connecting member 18. Blade unit 16 includes plastic housing 20, primary guard 22 at the front of housing 20, cap 24 with lubricating strip 26 at the rear of housing 20, five elongated blades 28 between primary guard 22 and primary cap 24, and trimming blade assembly 30 attached to the rear of housing 20 by clips 32, which also retain blades 28 on housing 20.

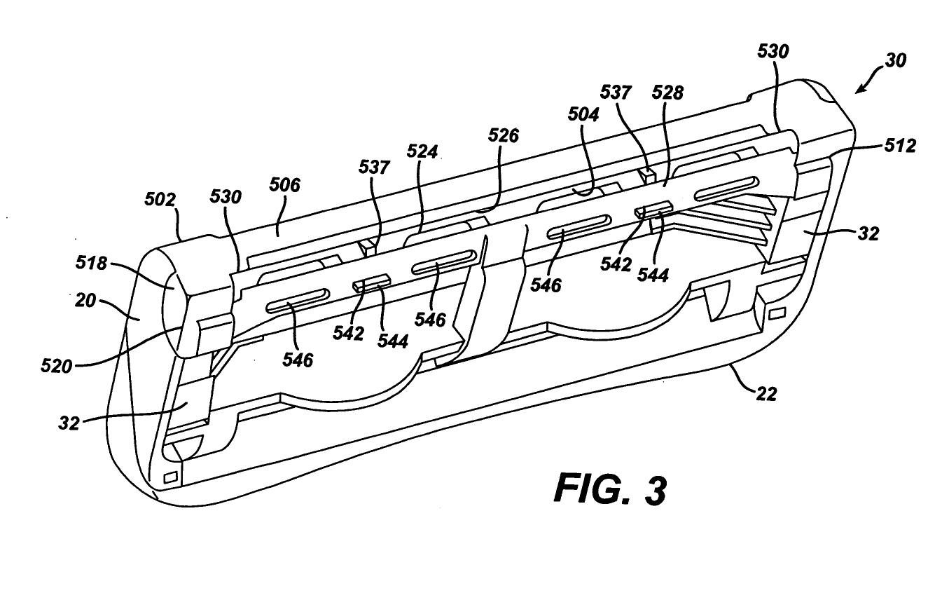

Referring to FIG. 3, trimming blade assembly 30 is secured to the back of housing 20 and includes blade carrier 502 and trimming blade 504 mounted thereon. Blade carrier 502 is made of 0.011″ thick stainless steel sheet metal that has been cut and formed to provide structures for supporting trimming blade 504 and defining a trimming guard and cap surfaces therefore and for attaching to housing 20.

Referring to FIGS. 3-9, blade carrier 502 has rear wall 506, upper tabs 508, 510 bent to extend forward at the two ends from the top of rear wall 506, lower wall 512 bent to extend forward along the length of rear wall 506 at the bottom of rear wall 506, and two lateral side portions 514, 516, each of which is made of a lateral tab 518 bent to extend forward from a respective side at an end of rear wall 506 and a vertical tab 520 bent to extend upward from a respective end of lower wall 512.

The central portion of rear wall 506 is open at its lower portion, providing a gap 522 that is located between lower, terminating surface 526 of rear wall 506 and trimming guard 528, which extends upward from lower wall 512. Two alignment surfaces 530 are positioned a precise distance from the bottom of terminating surface 526 at the two ends of terminating surface 526. Trimming blade 504 is welded to interior surface 532 of rear wall 506 by thirteen spot welds 534 with cutting edge 536 of trimming blade 504 aligned with alignment surfaces 530. All of the edges around gap 524, which will come in contact with the user's skin, are rounded to provide a radius of curvature of 0.2 mm so that they will not be felt by the user.

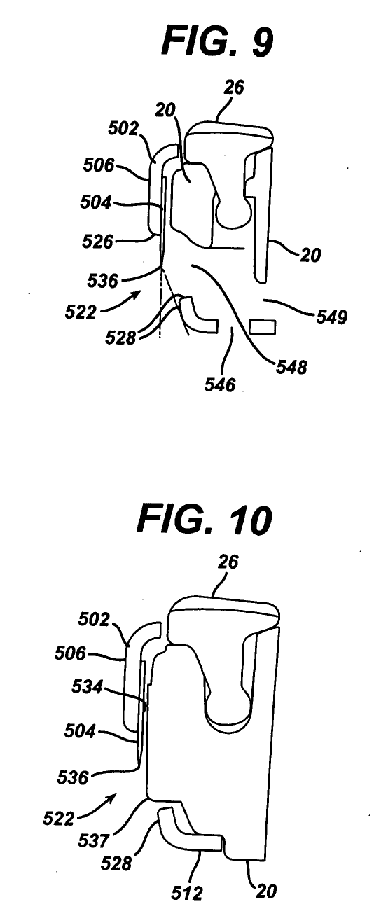

Referring to FIGS. 3, 5-10, gap 522 exposes cutting edge 536 of trimming blade 504. As is perhaps best seen in FIG. 9, rear wall 506 and its lower terminating surface 526 provide a trimming cap 535 for trimming blade 504 and its cutting edge 536 and define the exposure for trimming blade 504. Referring to FIGS. 3 and 10, two skin protection projections 537 spaced part way in from the two ends extend into the space behind a tangent line from trimming cutting edge 536 to trimming guard 528 to limit the amount that the user's skin can bulge into the space between the trimming cutting edge 536 and the trimming guard 528.

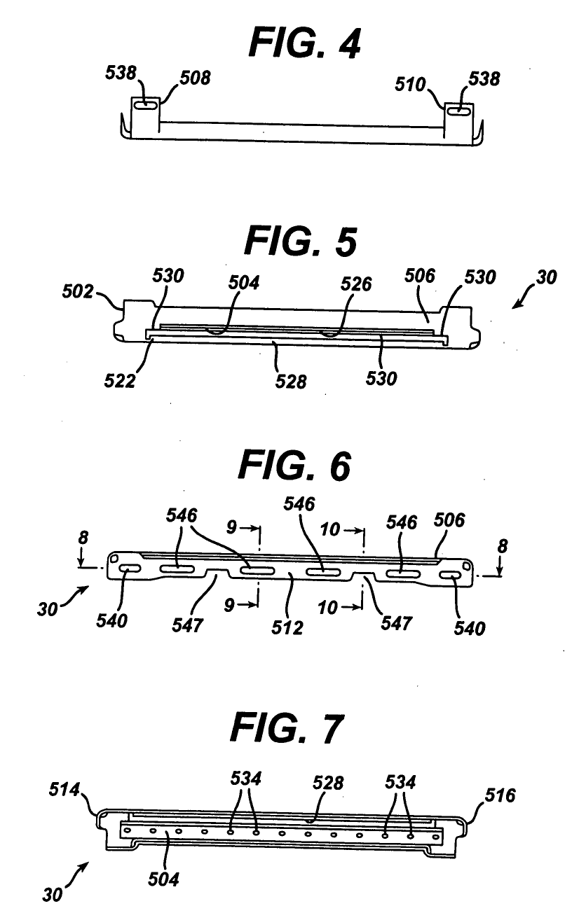

Referring to FIGS. 4 and 6, upper side tabs 508 and 510 have upper slots 538 and lower wall 512 has aligned slots 540 for receiving clips 30 used to secure trimming blade assembly 30 to housing 20. Referring to FIGS. 3 and 6, lower wall 512 also has recesses 542 for mating with projections 544 on housing 20 to facilitate aligning and retaining assembly 30 in proper position on housing 20.

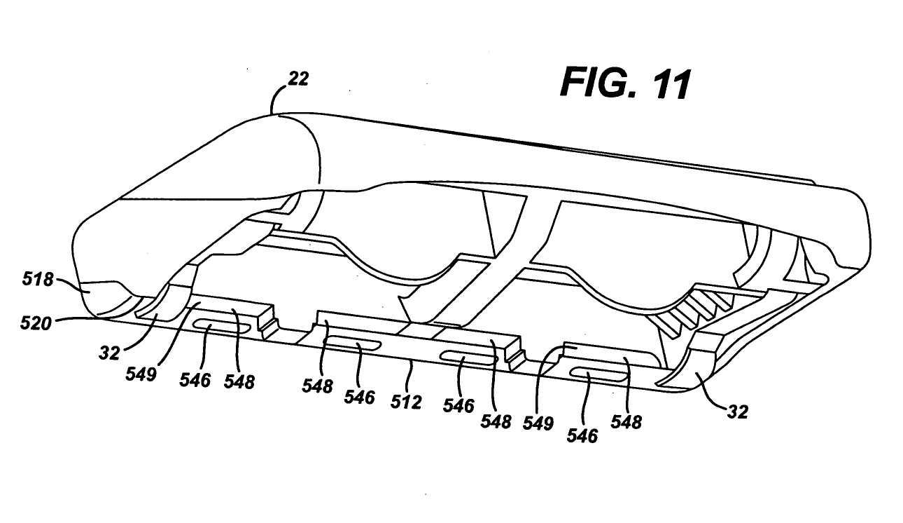

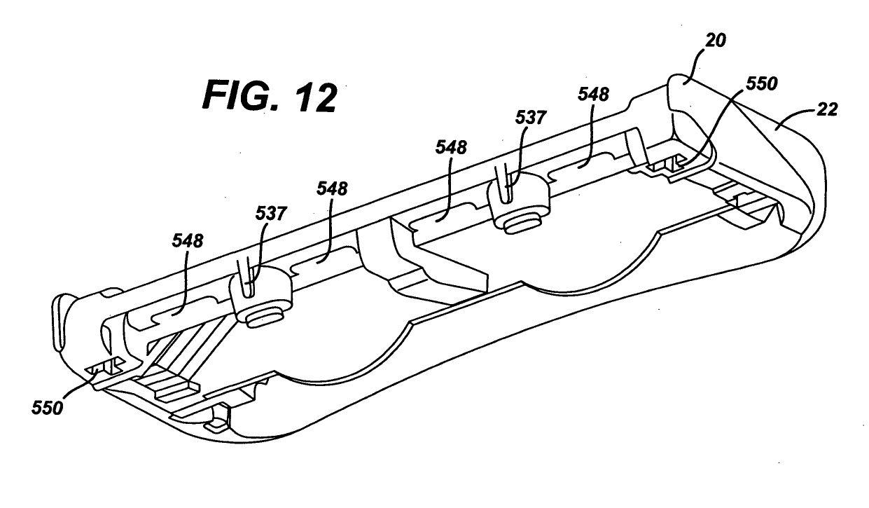

Referring to FIGS. 3, 6, 8, 9, 11, 12, lower wall also has four debris removal slots 546 that are aligned with four recessed debris removal passages 548 in housing 20 to permit removal of shaving debris from the region behind and below cutting edge 536 during shaving.

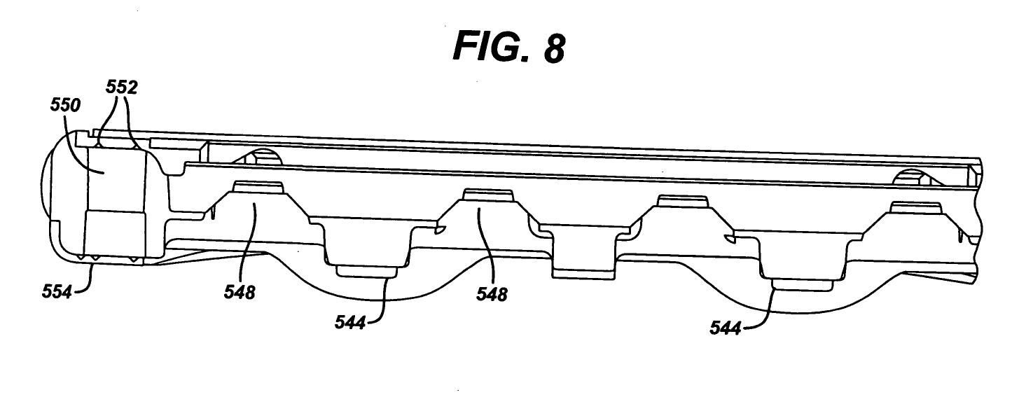

In manufacture, blade carrier 506 is cut and formed from sheet metal. Trimming blade 504 is then placed against interior surface 532 with cutting edge 536 aligned with alignment surfaces 530 with an automated placement member, and then secured to interior surface 532 by spot welds 534, with trimming cutting edge 56 in precise position with respect to trimming guard 528 and trimming cap 534. Trimming assembly 30 is then placed on the back of housing 20 by sliding it forward over the rear of housing 20 with recesses 542 on lower wall 512 aligned with projections 544 on housing 20. At the same time, upper crush bumps 552 and lower crush bumps 554 on housing 20 (FIG. 8) are deformed by compression applied between upper tabs 508, 510 and lower wall 512 when assembly 30 is moved forward onto the back of housing 20. Assembly 30 is then secured to housing 20 by clips 32, which pass through upper slots 538 and lower slots 540 on blade carrier 506 and aligned slots 550 through housing 20.

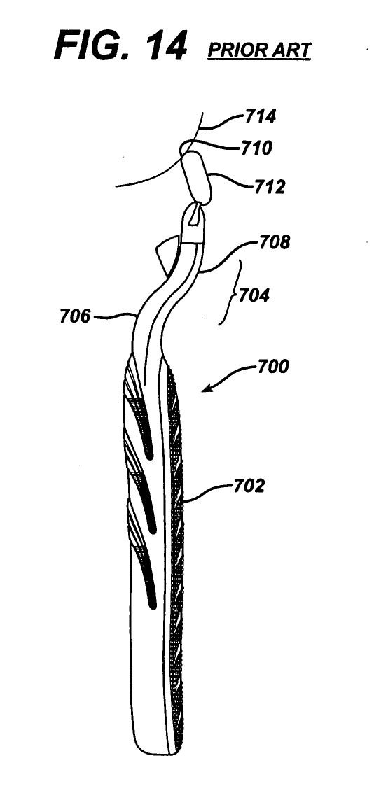

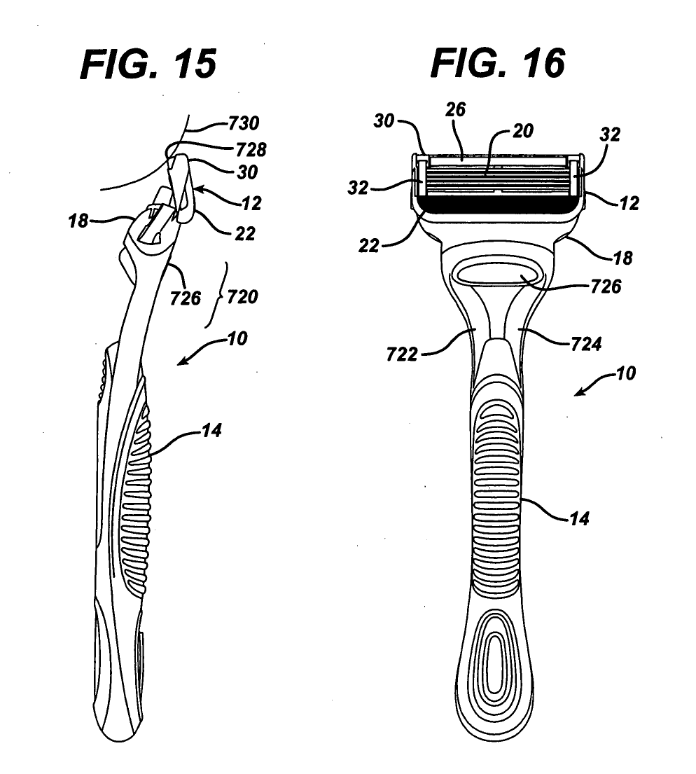

In use, the shaver rotates handle 14 180° from the position in which it is usually gripped such that the thumb is on finger pad 726 (FIGS. 14 and 15) on the side near primary guard 22, and moves the rear of the blade unit toward skin area to be shaved with trimming blade 504 in alignment with the edge of the hairs to be trimmed, e.g., at a location desired for a clean bottom edge of side burns or an edge of a mustache or beard or under a shaver's nose when shaving hairs in this otherwise difficult-to-shave location. The blade unit 16 is located at its at-rest a stop position with respect to connecting member 18, and thus does not pivot as the user presses the rear of the blade unit 16 and cutting edge 536 against the skin and then moves it laterally over the skin to trim hairs. Cut hairs and other shaving debris that are directed to the region behind cutting edge 536 during trimming pass through debris removal passages 548 in housing 20 and aligned debris removal slots 546 in lower wall during trimming and the entire region and the debris removal passages and slots are easily cleared during rinsing in water, e.g., between shaving or trimming strokes. The cut hairs and shaving debris can also pass through passages 549 behind passages 548 and above the lower wall 512.

The recessed location of cutting edge 536 of the trimming blade 504 with respect to the rear wall 506 of the blade unit avoids cutting of a user's skin during handling of the cartridge 12 and razor 10. Including a trimming blade and a trimming guard on a common assembly that is attached to a housing of a shaving razor blade unit facilitates accurate positioning of the trimming guard with respect to the trimming blade to provide accurate trimming blade tangent angle and trimming blade span.

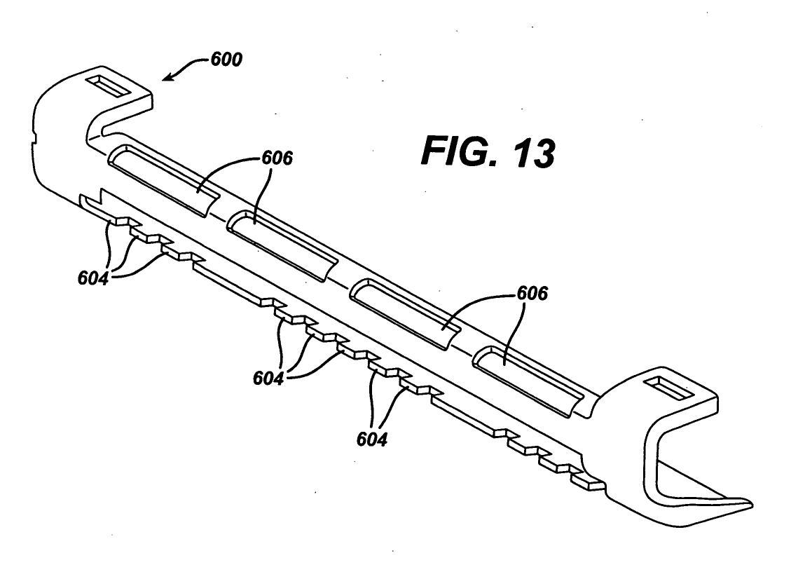

Referring to FIG. 13, alternative blade support 600 includes a comb guard 602 that has spaced segments 604 to facilitate removal of shaving debris, facilitate trimming of sideburns and other longer hairs, and facilitate providing accurately located guard surfaces during the forming of the guard in the manufacturing process. Blade support 600 also has rinsing openings 606 to permit removal of hairs trapped between trimming blade 504 and the housing 20 (see FIG. 9). In this embodiment, the space between the housing 20 and the blade is made larger than is shown in FIG. 10 to facilitate removal of cut hairs and shaving debris.

Referring to FIG. 14, it is seen that the Mach III type of handle design in razor 700, the end of handle 702 includes an S curve 704, including first curve 706, and second reverse curve 708, which bulges out at the location where a user would like to place a thumb or finger when using a trimming blade at the end 710 of cartridge 712 when trimming on skin surface 714 in order to provide accurate control.

Referring to FIGS. 15 and 16, handle 14 includes a single gentle curve 720 at the end being concave on the same side as primary blades 28. Handle 14 is bifurcated into two portions 722, 724, providing an empty region between them to provide access to finger pad 726 located on the concave side of curve 720. The gentle curve 720 on the same side as the primary blades and finger pad 726 and the access to pad 726 provided by the bifurcated handle permit the user to place a thumb or finger in line with and directly under the trimming blade 504, which is located at corner 728 shown in FIG. 14, when trimming sideburns or other whiskers or hairs on user's skin 730. Finger pad 726 is made of elastomeric material and has projections to provide good engagement. The inner surfaces 732, 734 of portions 722, 724 are relieved to provide access to finger pad 726.

Other embodiments of the invention are within the scope of the appended claims.

What is claimed is:

1. A shaving razor comprising
a housing having a primary guard at a front of said housing and a primary cap at an upper surface at a back of said housing, one or more primary shaving blades between said primary guard and said primary cap,
a trimming blade mounted at the back of said housing having a trimming blade cutting edge oriented away from said upper surface,
an elongated handle having a first end secured to said housing, said handle being bifurcated adjacent said first end into two portions such that there is a region between said two portions, the two portions joining at the first end to enclose the region, and
a finger pad positioned where said two portions join at said first end.

2. The shaving razor of claim 1 wherein said finger pad is made of an elastomeric material.

3. The shaving razor of claim 1 wherein there are three or more said primary shaving blades.

4. The shaving razor of claim 1 wherein there are four or more said primary shaving blades.

5. The shaving razor of claim 1 wherein there are five or more said primary shaving blades.

6. The shaving razor of claim 1 wherein said housing is pivotally connected to said handle by a connection that has an at rest stop position to prevent pivoting of said housing when the trimming blade is cutting hair.

7. The shaving razor of claim 1 wherein said handle has a curve at said first end that is concave on the same side as said primary blades.

8. The shaving razor of claim 1 wherein said finger pad is generally oval in shape.

9. The shaving razor of claim 1, wherein the finger pad is positioned on the same side as said primary blades.

10. A shaving razor comprising
a housing having a primary guard at a front of said housing and a primary cap at an upper surface at a back of said housing, one or more primary shaving blades between said primary guard and said primary cap,
a trimming blade mounted at the back of said housing having a trimming blade cutting edge oriented away from said upper surface,
an elongated handle having a first end secured to said housing, said handle being bifurcated adjacent said first end into two portions such that there is a region between said two portions, the two portions joining at the first end to enclose the region, and
a finger pad positioned on the same side as said primary blades where said two portions join at said first end.

11. The shaving razor of claim 10 wherein said finger pad is made of an elastomeric material.

12. The shaving razor of claim 10 wherein there are three or more said primary shaving blades.

13. The shaving razor of claim 10 wherein there are four or more said primary shaving blades.

14. The shaving razor of claim 10 wherein there are five or more said primary shaving blades.

15. The shaving razor of claim 10 wherein said housing is pivotally connected to said handle by a connection that has an at rest stop position to prevent pivoting of said housing when the trimming blade is cutting hair.

16. The shaving razor of claim 10 wherein said handle has a curve at said first end that is concave on the same side as said primary blades.

17. The shaving razor of claim 10 wherein said finger pad is generally oval in shape.
